(19) United States
(12) Patent Application Publication
(10) Pub. No.: US 2009/0296550 A1
(43) Pub. Date: Dec. 3, 2009

(54) OPTICAL RECORDING-REPRODUCING APPARATUS

(75) Inventor: Toshihiko Suzuki, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/465,200

(22) Filed: May 13, 2009

(30) Foreign Application Priority Data
May 28, 2008 (JP) 2008-139678

(51) Int. Cl. G11B 7/00

(52) U.S. Cl. 369/53.19; G9B/7

(57) ABSTRACT

An optical recording-reproducing apparatus comprises a laser beam source; an objective lens for focusing a laser beam from the laser beam source on a disk medium; an actuator for positional control of the objective lens; a tilt-compensating mechanism for adjusting inclination of the objective lens relative to the disk medium; a detecting element for detecting an amount of a change of the power of the laser beam for recording of information on the disk medium, wherein the tilt-compensating mechanism adjusts inclination of the objective lens according to the amount of the change of the power of the laser beam when the recording is carried out.

### BACKGROUND OF THE INVENTION

1. Field of the Invention

The present invention relates to an optical recording-reproducing apparatus for recording or reproducing information on or from a disk medium with a laser beam. In particular, the present invention relates to an apparatus, which is equipped with a tilt-compensating mechanism for recording or reproducing information exactly by use of the tilt-compensating mechanism.

2. Description of the Related Art

Japanese Patent Application Laid-Open No. H06-295458 discloses a technique of detection of a tilt of a disk medium by a tilt sensor provided on an optical pickup to control the recording laser power in accordance with the detected tilt.

Japanese Patent application Laid-Open No. 2001-023174 discloses a method of detecting a tilt of the disk medium by a tilt sensor provided on the pickup and controlling the reflected light pulse of the recorded information pattern (so-called write strategy) in accordance with the detected tilt.

Such techniques enable compensation of a tilt of a disk in a recording process.

The above Japanese Patent Application Laid-Open No. H06-295458 employs a tilt sensor placed on the optical pickup for compensating the tilt at an appropriate timing in the recording process. This results in a larger size and higher cost of the optical pickup.

The above prior art technique adjusts the recording power in accordance with the detected tilt, so that excessive upward compensation of the recording power can cause generation of a large amount of heat. This heat generation can cause thermal runaway of the system in a highly packed casing. On the other hand, above Japanese Patent Application Laid-Open No. 2001-023174 employs a separate tilt sensor, and controls the light emission timing of the recording pulse in accordance with the extent of the tilt, and the light-emission timing is controlled within a certain range to raise the temperature of the mark formation spot (so-called write strategy). This is equivalent to increase of the duty of the emitted light pulse, increasing inevitably the effective recording power to cause a temperature rise in the apparatus.

### SUMMARY OF THE INVENTION

The present invention intends to provide an optical recording-reproducing apparatus which is capable of compensating a tilt during recording with less heat generation by the recording power without installing an additional sensor.

The present invention is directed to an optical recording-reproducing apparatus comprising; a laser beam source, an objective lens for focusing a laser beam from the laser beam source on a disk medium, an actuator for positional control of the objective lens, a tilt-compensating mechanism for adjusting inclination of the objective lens relative to the disk medium, a detecting element for detecting an amount of a change of the power of the laser beam for recording of information on the disk medium, wherein the tilt-compensating mechanism adjusts inclination of the objective lens according to the amount of the change of the power of the laser beam when the recording is carried out.

The inclination of the objective lens can be adjusted by the tilt-compensating mechanism when the amount of the change of the power of the laser beam is larger than a prescribed amount.

In the optical recording-reproducing apparatus, a temperature-detecting element can be equipped for measuring a temperature of or near the laser beam source, and the inclination of the objective lens is adjusted by the tilt-compensating mechanism according to the amount of the change of the power of the laser beam and the temperature detected by the temperature-detecting element.

The apparatus can be equipped with a means for acquiring a focus-driving signal for focusing to the disk medium, and detects a direction of the tilt of the disk medium according to the focus-driving signal, and the inclination of the objective lens is adjusted by the tilt-compensating mechanism in accordance with the result of the detection.

The power of the laser beam can be adjusted in accordance with the amount of the compensation for tilt by the tilt-compensating mechanism.

Further features of the present invention will become apparent from the following description of exemplary embodiments with reference to the attached drawings.

### BRIEF DESCRIPTION OF THE DRAWINGS

FIG. 1 is a block diagram of the functions of the optical recording-reproducing apparatus.

FIG. 2 is a flow chart of operation of a first embodiment of the present invention.

FIG. 3 is a flow chart of operation of a second embodiment of the present invention.

FIG. 4 is a drawing for describing the tilt compensation.

FIG. 5 is a drawing for describing dependence of absorbance (recording sensitivity) on the laser wavelength on a disk containing an organic colorant.

FIG. 6 is a drawing for describing dependence of the optimum recording power on the laser temperature on a disk containing an organic colorant.

FIGS. 7A and 7B are a drawing for describing the average level of the focus-driving signal.

FIG. 8 is a drawing for describing the actuator-controlling signal.

FIG. 9 is a tilt compensation table in the second embodiment of the present invention.

FIGS. 10A and 10B are a drawing for explaining the entire operation in the first embodiment of the present invention.

FIGS. 11A and 11B illustrate a constitution of the actuator.

### DESCRIPTION OF THE EMBODIMENTS

Preferred embodiments of the present invention are described in detail with reference to drawings.

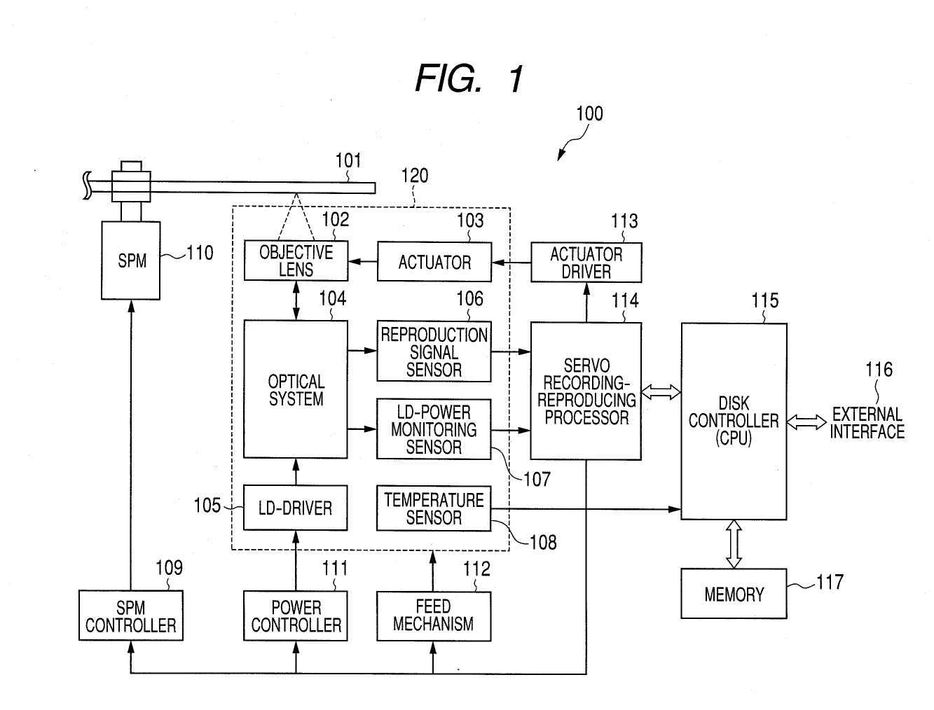

The tilt compensation of the present invention is applicable to an optical recording-reproducing apparatus like the one illustrated in FIG. 1.

[Constitutional Elements of Optical Recording-Reproducing Apparatus 100 and Serial Operations Therewith]

Optical recording-reproducing apparatus 100 comprises optical disk 101 (hereinafter referred to simply as a “disk”), optical pickup (OPU) 120, spindle motor (SPM) 110, spindle motor controller (SPM controller) 109, power controller 111, actuator driver 113, feed mechanism 112, servo recording-reproducing processor 114, and disk controller (CPU) 115.

The constitution shown in FIG. 1 and the operation thereof are described below.

Disk controller 115 has a CPU (central processing unit), and controls the operation of the entire optical recording-reproducing apparatus 100 by practicing a user's instruction command or a prescribed program from an operation system not shown in the drawing through external interface 116. The operation of recording or reproduction on the disk is controlled through memory 117 by a known shock proof control (intermittent driving).

Disk 101 is, for example, of a phase change type, which has a recording layer constituted of a phase-changeable material such as Ge—Sb—Te. On projection of an optical beam with a modulated intensity onto the rotating disk, the crystal state of the recording layer is changed reversibly between an amorphous state and a crystalline state. To change the crystalline state of the recording layer to an amorphous state, an optical beam (light flux) is projected in a pulse to melt the crystal once and the melt is quenched. Conversely, to change the amorphous state of the recording layer to a crystal state, a relatively weak optical beam is projected thereon to anneal the layer at a temperature higher than the crystallization temperature. Such a phase-change property enables storage of information by a binary system of 0 and 1.

Disk 101 may be of a write-once type having an organic colorant recording layer. In the write-once type disk, the strong optical beam projected on the recording layer is absorbed by the colorant film to cause thermal change to change the reflective index of the medium. Although this type of disk allows recording only once, the market therefor is growing rapidly owing to high compatibility between players in reproduction and to a relatively low price.

Next, the servo recording-reproducing process by disk controller 115 and servo recording-reproducing processor 114 is described below. Servo recording-reproducing processor 114 controls the rotation drive of spindle motor (SPM) 110 by SPM controller 109. The spindle motor rotation is controlled by a so-called CLV (Constant Linear Velocity). The track groove on disk 101 has a meandering side wall called a wobble. The rotation speed of the disk is controlled to obtain an intended frequency of the wobble.

OPU 120 is constituted of objective lens 102, actuator 103, optical system 104, LD-driver 105, reproduction signal sensor 106, LD-power-monitoring sensor 107, and temperature sensor 108. OPU 120 is connected through a flexible cable or the like to servo recording-reproducing processor 114 or a motor actuator driver system.

Objective lens 102 is adjusted to compensate the tilt by applying an electric current to the coil and wire constituting actuator 103. This is described later in detail.

LD-driver 105 drives a semiconductor laser device (hereinafter referred to as “LD”). The laser beam emitted from the LD is focused through optical system 104 and objective lens 102 on disk 101. LD-power-monitoring sensor 107 is constituted of a semiconducting optical sensor and a photoelectric conversion amplifier. A part of the laser beam emitted from the LD forms a loop of APC (automatic power control) by LD-power-monitoring sensor 107, servo recording-reproducing processor 114, and power controller 111. Thereby, the LD emission power is feedback-controlled to adjust the output of the LD-power-monitoring sensor to accord with a prescribed power level set by disk controller 115.

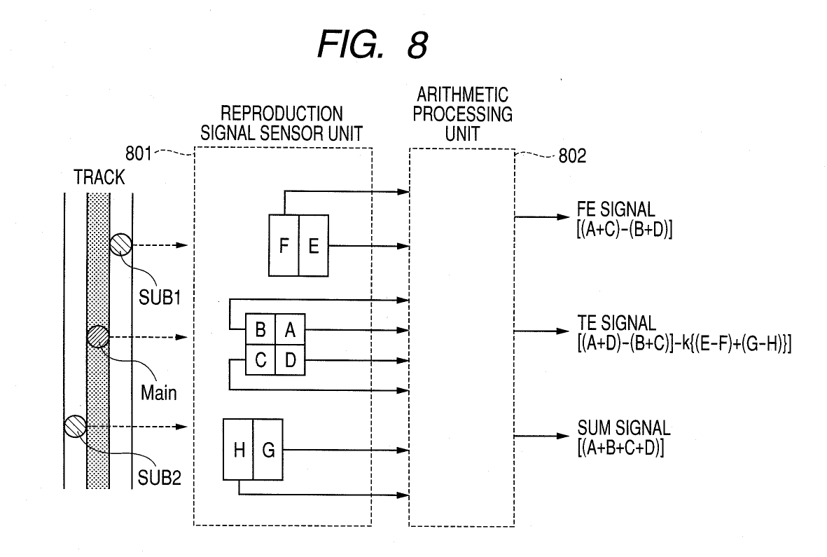

Reproduction signal sensor 106 is constituted of a semiconducting optical sensor and a photoelectric conversion amplifier. FIG. 8 illustrates placement of optical spots on the disk, a constitution of the reproduction signal sensor 801, and the arithmetic processing unit 802 of the servo recording-reproducing processor.

In FIG. 8, the main beam (Main) is controlled to direct the track center. Sub-beams (SUB1, SUB2) are controlled to deviate positionally in the radial direction by a ½ track from the main beam (a differential push-pull method).

In the reproduction-signal sensor unit, the reflected light of the main beam (Main) is introduced to four-division sensor (A-D), and the reflected light of the sub-beams (SUB1, SUB2) are introduced to two-division sensors (E-F, G-H). The output of the reproduction signal sensor is transmitted from OPU 120 through a flexible cable or the like to the arithmetic processing unit of servo recording-reproducing processor 114. The arithmetic processing unit processes the channel signals A-H by automatic gain control, pre-filtering, and analog/digital conversion. The entire of the reflected light of the main beam, SUM, is calculated and is output as SUM=A+B+C+D. The differential signal of the diagonal sum of the four-divisional sensor is calculated and is output as a focusing error signal (FE signal) of the main beam (astigmatism method): FE=(A+C)−(B+D).

The push-pull signal of the main beam is derived as (A+D)−(B+C). This contains an off-set caused by shift of the objective lens in the disk radius direction. Therefore, the tracking error signal (TE signal) without the offset component can be derived from the push-pull component (E−F)+(G−H) multiplied by a prescribed factor k, and difference calculation: TE=(A+D)−(B+C)−k[(E−F)+(G−H)].

The prescribed factor k is a constant decided in accordance with the divided light quantity ratio of the main beam and the sub-beams.

As described above, the focus of the optical beam spot is controlled according to the focus error signal (FE signal). Further, the tracking is controlled by follow-up of the optical beam spot to the information track in the groove direction according to the tracking error (TE) signal.

The tracking is controlled by fine adjustment by actuator 103, and coarse adjustment by feed mechanism 112. More specifically, on detection of the position of the objective lens within the actuator movement range, the feed mechanism is actuated to move the entire of OPU 120 in the disk radius direction. Thereby the optical beam spot is controlled to follow the intended track on the disk by fine adjustment by the actuator and by displacement of OPU by the feed mechanism. Feed mechanism 112 displaces OPU 120 in the disk radius direction (for traverse control) for seeking the intended address.

The digitalized reproduction signal is processed by a clock produced in synchronization with the edge of the reproduction signal by PLL (phase-locked loop: not shown in the drawings). Further, the data is processed for prescribed decoding such as data detection by PRML (partial-response maximum-likelihood) and ECC (error correction code).

For recording on the disk, a recording pattern is formed by servo recording-reproducing processor 114 by modulation in accordance with a disk format. LD-driver 105 corrects the waveform and controls the timing of the laser emission pulse for the recording pattern, a so-called write strategy.

Disk controller 115 conducts recording by a shock proof operation. Specifically, the disk access is conducted intermittently by utilizing the difference between the rate (low speed) of data input-output and the rate (high speed) of recording on the disk. That is, during storing the signal from the outside interface in memory 117, the disk access is kept in a halt state. The term “halt state” herein signifies switch-off of the power-consuming LD and stop of operation of the related electric circuit block. When an intended amount of the data has been stored in memory 117, the access to the disk is started for recording, and the data in memory 117 is recorded in disk 101. After completion of the recording in the disk, the disk access is halted again. Such an intermittent disk access with switch-off of the LD enables reduction of the average power consumption. This also enables servo return (retry), even when vibration or impact is applied from the outside, by buffering by memory 117 to improve the anti-shock reliability.

Temperature sensor 108 is provided inside OPU 120 to detect the temperature around the LD by disk controller 115.

### First Embodiment

<Flow of Tilt Compensation in Optical Recording-Reproducing Apparatus 100>

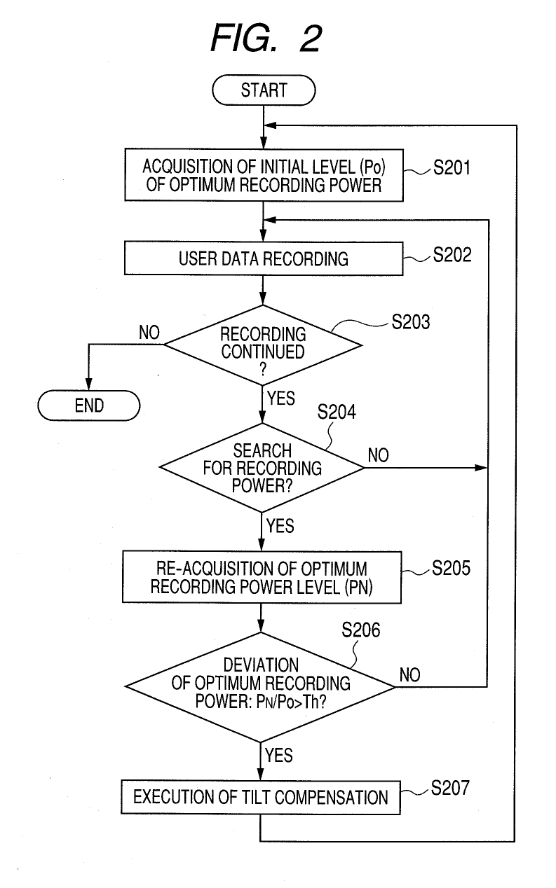

FIG. 2 is a flow chart illustrating a first method of tilt compensation according to the present invention. The flow of the compensation is described specifically with reference to FIG. 2.

[Step S201: Acquisition of Initial Level (Po) of Optimum Recording Power]

This step acquires the initial level (Po) of the optimum power for recording on the disk.

Disk controller 115 conducts optimum power control (OPC) for setting the recording laser power in accordance with instructions given by a higher-level command. Specifically, OPU 120 is moved to a prescribed area (PCA: a power calibration area), and trial recording and reproduction are conducted. The trial recording is conducted at plural levels of the recording laser power. At the reproduction of the recorded data by the trial, the data is reproduced at the respective recording power levels to evaluate the signal quality. The signal quality is evaluated by reference to indexes such as an asymmetry factor (β number), a jitter level indicating fluctuation of the edge, and error ratio indicating the reliability of the reproduced data. The power level for the best recording quality is selected as the optimum recording power.

The selected optimum recording power (Po) is stored in a prescribed register together with the conditions such as the time and the temperature for selection of the Po.

In the step S201, the OPC (optimum power control) need not be conducted in the prescribed PCA area, but the trial recording may be conducted in the user data area. Otherwise, the optimum recording power may be decided by reproduction of a previously recorded data.

[Step S202: User Data Recording]

Disk controller 115 conducts the recording on the disk at the optimum recording power stored in the prescribed resister. Disk controller 115 conducts recording intermittently or continuously under the instructions of the higher-level command.

[Step S203: Recording Continued?]

This step decides whether the recording operation is continued or stopped. The operation goes to Step S204 under instruction by the higher-level command for the continuation of the recording, whereas the operation goes to the step END to stop the operation under instruction for the stop of the recording.

[Step S204: Search for Recording Power?]

Disk controller 115 judges necessity for another search for the recording power. For example, after a lapse of time longer than a prescribed time length after setting of the initial level (Po) of the optimum recording power, the recording power should be searched. Or when the temperature has changed out of the prescribed temperature range after the setting of the initial level of the optimum recording power, the recording power should be searched. Further, when the quality of reproduction of the recorded data has become lower than the prescribed level, the recording power should be searched. In such a manner, when the recording power should be searched again, the operation is allowed to proceed from S204 to step S205. When the additional search for the recording power is not necessary, the operation is returned to the step S202 to continue the recording operation.

[Step S205: Re-Acquisition of Optimum Recording Power Level (PN)]

This step corrects the optimum recording power in the disk user data area in the same manner as in S201 except that disk controller 115 stores the acquired optimum recording power PN in a resistor other than that for the initial power Po acquired in the step S201. Thus, the optimum recording power PN acquired in the step S205 is stored as PN in the register for updating every time when the additional search is judged to be necessary in the step S204. The registered PN value of the optimum recording power stored is set for the recording operation in the step S203.

[Step S206: Judgment of Deviation of Optimum Recording Power]

In this step, the deviation of the optimum recording power out of the prescribed power range is detected to judge whether or not the tilt compensation is necessary in the next step S207.

For example, disk controller 115 derives the ratio of the power level stored in the Po register and that stored in the PN register, and compares the ratio (PN/Po) with the prescribed threshold level (Th level). When the deviation of the optimum recording power PN/Po is found to be larger than the prescribed Th level (PN/Po>Th), the operation goes to the step S207. Otherwise the operation returns to the step S202 to continue the recording operation.

In this embodiment, the Th level is set at 1.1 as an example. Therefore, when the updated recording power PN exceeds +10% of the initial recording power Po, the operation of the step S207 is conducted.

The index for monitoring the variation of the optimum recording power is not limited to the PN/Po ratio, but may be an absolute value of the difference between PN and Po, or an amount of the updating of PN. Thus, the amount of the deviation of the optimum recording power is detected, and the subsequent tilt compensation operation is executed according to the detected amount of the deviation as described below.

[Step S207: Execution of Tilt Compensation]

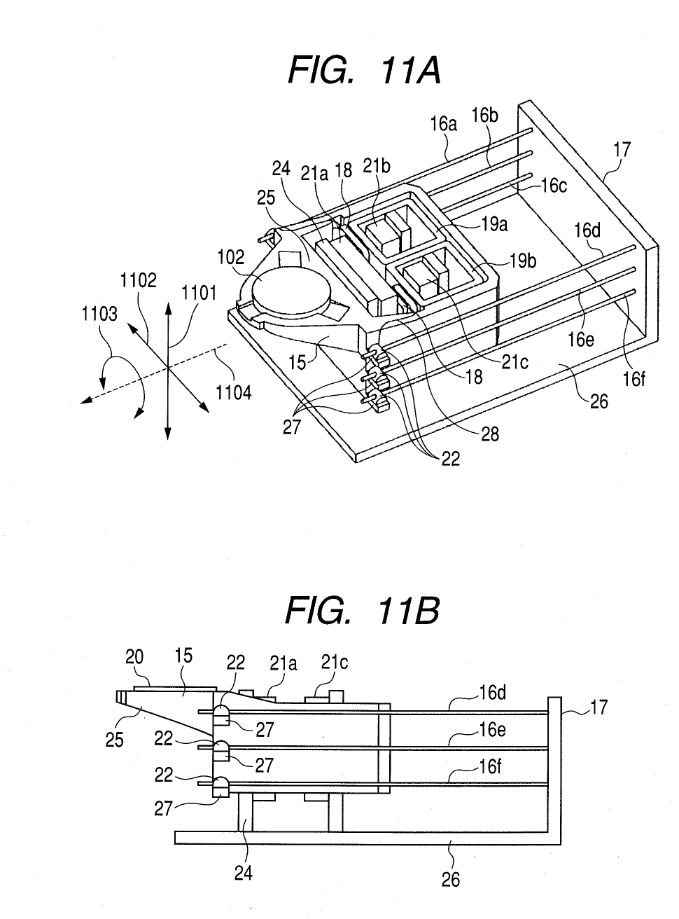

The tilt compensation is described below in detail with reference to drawings. FIGS. 11A and 11B illustrate a constitution of actuator 130: FIG. 11A is a perspective view, and FIG. 11B is a side view. Actuator 130 is constituted of fixed part 26 and movable part 25. Fixed part 26 is constituted of permanent magnets 21a, 21b, 21c; yoke 24; and supporting base plate 17. Movable part 25 is constituted of objective lens 102; focusing coils 19a, 19b; tracking coil 18; and lens-holding member 15 for holding the lens and the coils.

Wires 16a, 16b, 16c, 16d, 16e, 16f are straight, and elastic and highly electroconductive. The one end of each of the coils is connected to supporting base plate 17, and the other end thereof is connected to side face of lens-holding member 15 to enable movable part 25 to move freely relatively to the optical disk in a focusing direction 1101, a tracking direction 1102, and a radial tilt direction 1103. Incidentally, numeral 1104 denotes the tangential direction.

The winding ends 28 of the coils of focusing coils 19a, 19b, and tracking coil 18 are connected to wires 16a, 16b, 16c, 16d, 16e, 16f through terminals 27 provided on the side face of lens-holding member 15.

Actuator driver 113 (FIG. 1) transmits focus-driving signals to focusing coils 19a, 19b, and tracking signals to tracking coil 18 in accordance with a focusing error signal and a tracking error signal. Actuator 130 drives movable part 25 by an electromagnetic force generated by magnetic fluxes generated by permanent magnets 21a, 21b, 21c according to the driving signals in three directions in relation to the optical disk. The three directions include the focusing direction 1101 for focusing between the optical disk and the objective lens; the tracking direction 1102 perpendicular to the track grooves; and the radial tilt direction 1103 of inclining the objective lens in the radius direction by applying thrusting forces by two focusing coils 19a, 19b. The focus-driving signal is a current-signal transmitted to the focusing coils 19a, 19b for keeping the focusing error signal at a prescribed level.

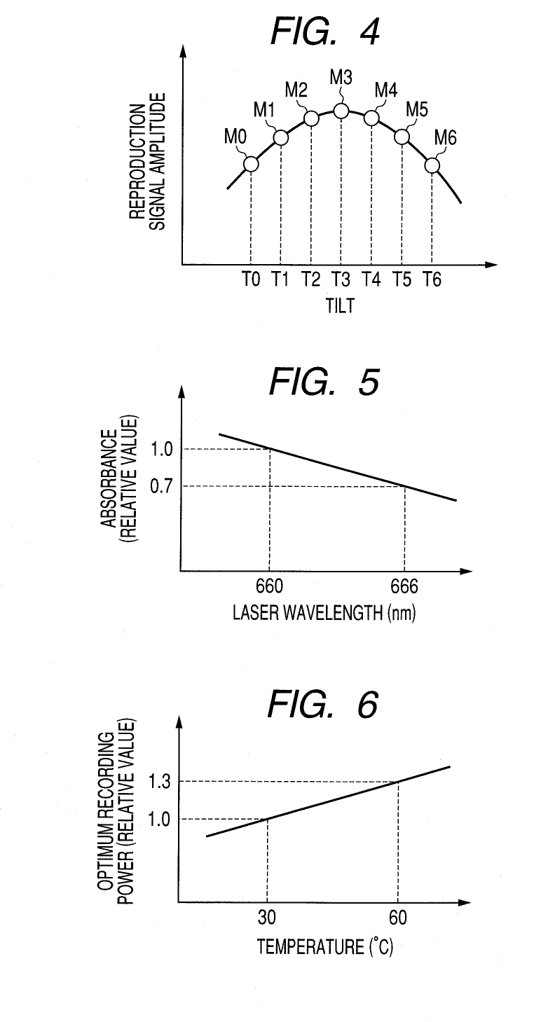

In the step S207 of tilt compensation, warpage of the disk is compensated by disk controller 115. FIG. 4 is a drawing for describing an operation sequence of the tilt compensation. In FIG. 4, the abscissa indicates the setting of the tilt of the objective lens, and the ordinate indicates the amplitude of the reproduction signal. Specifically, objective lens 102 is inclined at several levels rightward and leftward from the disk tangent direction, for example, levels of T0 to T6. The amplitudes M0 to M6 are derived for the respective tilt levels T0 to T6, and the tilt for maximizing the amplitude of the reproduction signal is derived. The increase of the tilt between the objective lens center (optical axis) and the disk face causes coma aberration to decrease the reproduction signal amplitude. In the example shown in FIG. 4, tilt T3 is selected which gives the maximum reproduction signal amplitude M3. The tilting should be made in the extent to obtain the maximum reproduction signal. For searching the maximum amplitude, for example in FIG. 4, tilts T0 and T6 of nearly equal amplitudes M0 and M6 are detected and the middle value thereof is selected effectively.

After the step of tilt compensation S207, the operation returns to the step S201, and the initial value (Po) of the optimum recording power is updated. This updating is necessary since tilt compensation S207 can change the effective intensity of the optical beam spot to cause deviation of the optimum of the recording power.

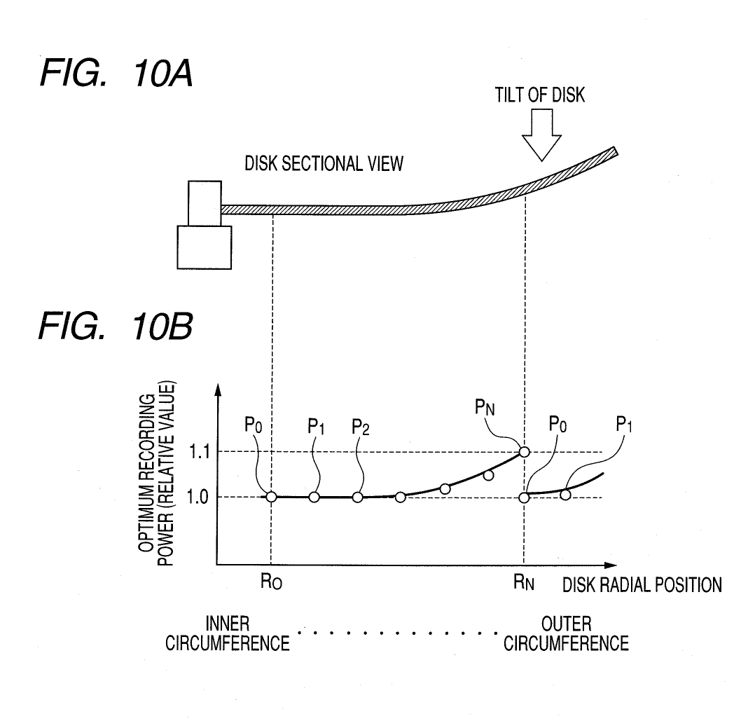

The entire image of the tilt compensation in this embodiment is described supplementally with reference to FIGS. 10A and 10B. FIGS. 10A and 10B are a schematic sectional view of a disk to show the tilt (warpage) of the disk and a graph to show a dependency of the optimum recording power on the radial position. In FIG. 10B, the optimum recording power Po is derived at a radius Ro (step S201). The disk controller seeks the optimum recording power at prescribed intervals, for example at every radial position (address) on the disk, and updates the optimum recording power like P1 and P2 (Step S205). Without a tilt (warpage) of the disk, the optimum recording power is kept nearly constant. Toward the periphery of the disk, the optimum recording power rises owing to the tilt effect. At the outer circumference RN, when the optimum recording power PN has increased to give the ratio PN/Po exceeding the Th level (1.1) (Step S206), the tilt compensation is executed (Step S207). Then the initial level Po of the optimum recording power is derived (Step S201). Thereafter the recording operation is continued with monitoring the optimum recording power.

The flow of the first embodiment of the present invention is described above in detail. In the step S206, the tilt compensation can be conducted at a suitable timing during the recording by monitoring the deviation of the optimum recording power.

Generally, the tilt (warpage) is caused by rapid change of the temperature or humidity in the apparatus, storage conditions of the disk, or characteristic disk composition. Therefore, the occurrence of the tilt in the system cannot be predicted. In particular, in real time recording of high-quality image data containing many codes, the recovery of the recorded data with verification is not easy.

In this embodiment, the tilt can be compensated at any time as necessary. The tilt can be detected surely and can be compensated to improve exactly the reliability of the recording-reproducing system. Further, coma aberration which is caused by the tilt of the disk can be decreased by the tilt compensation. Thus the compensation method employing the device of the present invention is entirely different from the method of the prior art (Japanese Patent Application Laid-Open 2001-023174) which controls the laser power to improve the recording quality. The method of the present invention decreases a temperature variation inside the apparatus, being different from the prior techniques.

### Second Embodiment

A second embodiment of the present invention is described below. This embodiment is different from the first embodiment in that the tilt is compensated in accordance with the focus-driving signal and the variation of the laser temperature.

Firstly, the direction of the positional change of the objective lens by OPU 120, toward or apart from the disk, can be detected by utilizing the focus-driving signal. Therefore, the tilt can be compensated in a time shorter than in the first embodiment.

Secondly, the variation of the optimum recording power for the variation of the laser temperature is preliminarily calibrated and the calibration table is memorized in the recording-reproducing apparatus and thereby the influence of the coma aberration caused by the disk tilt can be extracted. Thereby the tilt can be compensated to correct the coma aberration. The compensation is described below in detail.

<Tilt Compensation Flow in Optical Recording-Reproducing Apparatus 100>

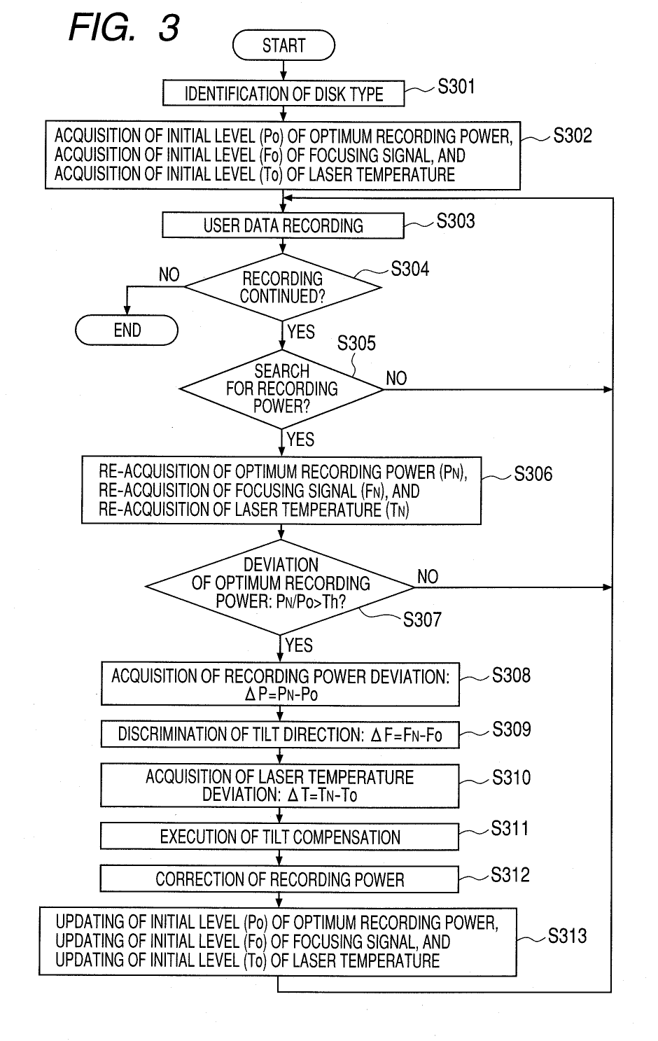

FIG. 3 is a flow chart of tilt compensation in Second Embodiment of the present invention. In this embodiment, the amount of the tilt compensation is decided by monitoring the variation of the optimum recording power, whereby the tilt is compensated and the optimum recording power is corrected. The flow is specifically described with reference to FIG. 3.

[Step S301: Identification of Disk Type]

This step identifies the type of the disk, the type such as an RW type utilizing a phase change, and an R type for write once, and simultaneously recognizes the disk manufacturer by reading ID of the manufacturer from the disk information. The information on the disk manufacturer is utilized later for identification of the properties of the recording film of the disk.

[Step S302: Acquisition of Initial Level (Po) of Optimum Recording Power, Initial Level (Fo) of Focus-Driving Signal, and Initial Level (To) of Laser Temperature]

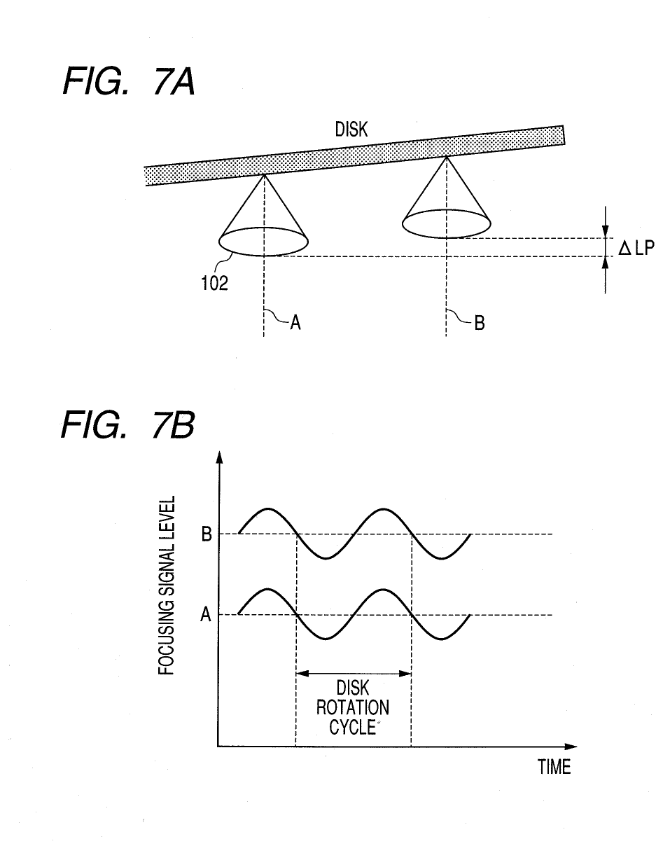

This step acquires the initial level (Po) of the optimum recording power, the initial level (Fo) of the focus-driving signal, and the initial level (To) of the laser temperature respectively, and stores the acquired levels in the prescribed registers in disk controller 115. The process of acquiring the optimum recording power is conducted in the same manner as in Embodiment 1 described above. The process for acquiring the initial level (Fo) of the focus-driving signal is described with reference to the drawing. FIG. 7A illustrates positions of the objective lens at radial positions A and B on the disk. FIG. 7B illustrates transition of the focus-driving signal of actuator 103 with time.

The focus-driving signal follows deflection of the disk face, changing upward and downward in synchronization with the disk rotation cycle. The average level of the focus-driving signal varies in correspondence with the relative position between OPU 120 and objective lens 102. FIGS. 7A and 7B illustrate warp of the disk at the position B. In this state, the distance between the OPU and objective lens 102 is larger at the radial position B than at the radial position A by the distance ALP and the average level of the focus-driving signal is higher at the point B than at the point A (B>A).

In this step, the average level (Fo) of the focus-driving signal is acquired simultaneously with detection of the initial level (Po) of the optimum recording power. The detected initial level (Fo) of the focus-driving signal is stored in a prescribed register. Thereafter, the variation of the average level of the focus-driving signal is monitored to detect the variation of the distance between the objective lens and OPU 120.

The disk controller acquires temperature information (To) near the LD from temperature sensor 108 and stores the information in the memory.

[Step S303: User Data Recording]

Disk controller 115 conducts the recording operation by setting the optimum recording power stored in the prescribed register, continuously or intermittently under the instructions of the higher-level command.

[Step S304: Recording Continued?]

This step decides whether the recording operation is continued or stopped. The operation goes to Step 305 under instruction by the higher-level command for the continuation of the recording, whereas the operation goes to the step END to stop the operation under instruction for the stop of the recording.

[Step S305: Search for Recording Power?]

Disk controller 115 judges necessity for another search for the recording power. For example, after a lapse of time longer than a prescribed time length after setting of the initial level (Po) of the optimum recording power in the step S302, the recording power should be searched. Or when the temperature has changed out of the prescribed temperature range after the setting of the initial level of the optimum recording power, the recording power should be searched. Further, when the quality of reproduction of the recorded data has become lower than the prescribed level, the recording power should be searched. In such a manner, when the recording power should be searched again, the operation is allowed to proceed from the step S305 to the step S306. When the additional search for the recording power is not necessary, the operation is returned to the step S303 to continue the recording operation.

[Step S306: Re-Acquisition of Optimum Recording Power Level (PN), Focus Driving Level (FN), and Laser Temperature (TN)]

This step acquires again the optimum recording power level on the disk, the average level of the focus-driving signals, and the laser temperature in the same manner as in the step S302. However the disk controller 115 stores the acquired optimum recording power PN and the focus-driving signal FN in a register other than the ones employed in the step S302 for storing the initial level (Po) of the optimum recording power, the initial level (Fo) of the focus-driving signal, and the initial level (To) of the laser temperature. Thus every time when the search is judged to be necessary in the step S305, the data are stored as PN, FN, and TN in a register for updating. The latest levels of the optimum recording power are stored in the register and are set in the recording operation in the step S303.

[Step S307: Judgment of Deviation of Optimum Recording Power]

In this step, disk controller 115 derives the ratio of the power level stored in the Po register to the power level stored in the PN register, and compares the ratio with the prescribed threshold value (Th level). When the change of the optimum recording power PN/Po is judged to be larger than the prescribed Th level (PN/Po>Th), the operation proceeds to the step S308. Otherwise the operation is returned to the step S303 to continue the recording operation.

In this embodiment, the Th level is set, for example, at 1.05. Therefore, when the updated recording power PN exceeds +5% relative to the initial recording power Po, the operation of the step S308 is conducted. In this embodiment, the extent of the tilt adjustment is calculated and changed.

[Step S308: Acquisition of Recording Power Deviation ΔP]

Disk controller 115 acquires the amount of deviation ΔP of the optimum recording power. ΔP=PN/Po

[Step S309: Acquisition of ΔF for Discrimination of Tilt Direction]

Disk controller 115 acquires the tilt direction by comparison of the average level FN of the focus-driving signals with the registered level of Fo. If ΔF=FN−Fo>0, the disk face is leaving apart from the laser source, whereas if ΔF=FN−Fo<0, the disk is coming near to the laser source.

[Step S310: Acquisition of Laser Temperature Deviation ΔT]

The disk controller 115 detects the temperature. That is, temperature sensor 108 measures the LD temperature deviation ΔT: ΔT=TN−To.

Disk controller 115 has plural built-in registers, and ΔP, ΔF, and ΔT are calculated by data access to the registers.

[Step S311: Execution of Tilt Compensation]

Disk controller 115 compensates the tilt according to the results of the measurement in Steps S301, S308, S309, and S310. As an example, the amount of the tilt compensation is calculated for ΔP=1.2, ΔF>0, and ΔT=10° C.

Firstly, the amount of compensation of optimum recording power deviation ΔP is derived. As an example, FIG. 5 shows the relation of absorbance (Abs) with the laser wavelength on a write-once disk of an organic colorant type. In FIG. 5, the abscissa indicates the laser wavelength (nm). FIG. 5 shows that the absorbance (corresponding to the recording sensitivity) decreases by 5% for a wavelength change of +1 nm. Generally, in this wavelength range, the semiconductor laser light source has temperature dependency of about +0.2 nm/° C. That is, the laser wavelength change of 6 nm corresponds to a laser temperature change of about 30° C. Thus, the laser temperature change causes change of the wavelength of the laser light source, and further causes change of the recording sensitivity of the disk. FIG. 6 shows dependency of the optimum recording power (ordinate) on the temperature (abscissa) with a disk having the absorption characteristics shown in FIG. 5. FIG. 6 shows that a rise of the laser temperature by 30° C. necessitates increase of the optimum recording power by 30%. The absorption characteristics of the write-once type disk depends on the organic colorant, being different with the disk makers. This step corrects the optimum recording power in accordance with the laser temperature change ΔT and the type of the disk.

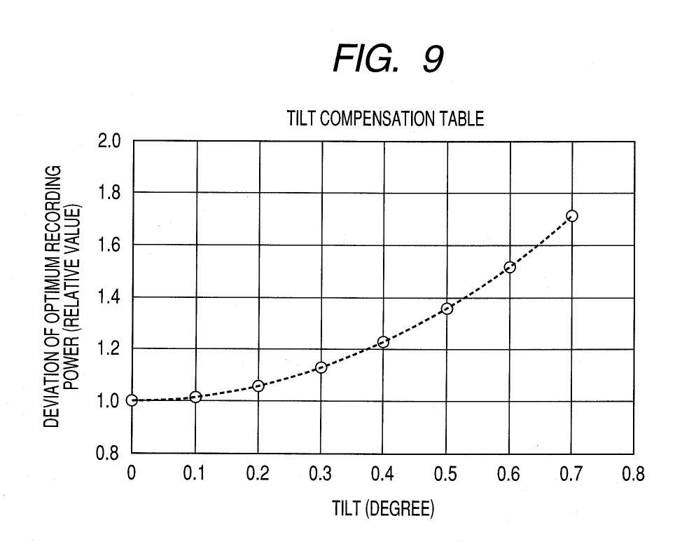

FIG. 9 shows the change ΔP of the optimum recording power for the tilt compensation with the recording-reproducing apparatus of this embodiment. In FIG. 9, the abscissa indicates the tilt (angular degree), and the ordinate indicates the change ΔP of the optimum recording power. The optimum recording power depends also on the laser temperature. Therefore, the change ΔP of the optimum recording power is a function of the tilt as well as the temperature change. Therefore, the relation between the laser temperature change ΔT and the optimum recording power change ΔP is summarized in a table for the type of the disk and is stored in the recording-reproducing apparatus, and only the influence of the tilt is extracted.

In FIG. 6, the temperature coefficient of the change ΔP of the optimum recording power is +1%/° C.

When ΔT=10° C. in the step S310, this temperature change causes the increase of the optimum recording power by 10%. Therefore, in this case, of the change of the optimum recording power ΔP=1.2 derived in the step S308, the substantial effect of the tilt is ΔP−10%=1.1 (relative value) of the optimum recording power. From FIG. 9, at the change of the optimum recording power ΔP=1.1, the tilt (represented by the abscissa) is 0.25 (degree). Therefore, the tilt is corrected by 0.25 degree toward the disk.

[Step S312: Correction of Recording Power]

This step cancels partly the excessive optimum recording power corresponding to the tilt compensation made in the step S311.

Of the change of the optimum recording power ΔP=1.2 acquired in the step S303, the effect of the tilt compensation corresponding to 10% is canceled to decrease the optimum recording power by 10%.

[Step S313: Updating of Initial Levels of Optimum Recording Power (Po), Focus-Driving Signal (Fo) and Laser Temperature (To)]

After the above tilt compensation, the initial levels of the optimum recording power Po, focus-driving signal Fo, and the laser temperature are updated.

In this embodiment, the necessary tilt change is definitely decided in accordance with the change of the optimum recording power to compensate the tilt. Usually, for search of the best position of the tilt state by driving the actuator, the searching time of several hundred milliseconds is required. In this embodiment, such a tilt adjustment step is omitted and the amount of the tilt to be changed can be determined and the tilt is compensated at one time advantageously. As described above, the tilt occurrence is detected precisely and the tilt is compensated surely, whereby the reliability of the recording-reproducing system is greatly improved.

The tilt compensation decreases also the coma aberration caused by the inclination of the disk. Therefore, this technique is completely different from prior art techniques (e.g., Japanese Patent Application Laid-Open No. 2001-023174) for improving the recording quality by controlling the laser power. Further, the present invention can decrease the temperature change in the apparatus differently from the prior art techniques.

In this embodiment, the tilt in the disk radius direction (radial tilt) is compensated. However, the compensation is not limited thereto, and tilt compensation can also be conducted in the tangential direction. Further, preferred constitutions of embodiments of the present invention are described in consideration of the hardware, but the gist of the present invention is not limited thereto, but can naturally be conducted by program processing of the software only.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-139678, filed May 28, 2008, which is hereby incorporated by reference herein in its entirety.

What is claimed is:

1. An optical recording-reproducing apparatus comprising:
a laser beam source;
an objective lens for focusing a laser beam from the laser beam source on a disk medium;
an actuator for positional control of the objective lens;
a tilt-compensating mechanism for adjusting inclination of the objective lens relative to the disk medium; and
a detecting element for detecting an amount of a change of the power of the laser beam for recording of information on the disk medium,
wherein the tilt-compensating mechanism adjusts inclination of the objective lens according to the amount of the change of the power of the laser beam when the recording is carried out.

2. The optical recording-reproducing apparatus according to claim 1, wherein the inclination of the objective lens is adjusted by the tilt-compensating mechanism when the amount of the change of the power of the laser beam is larger than a prescribed amount.

3. The optical recording-reproducing apparatus according to claim 1, wherein a temperature-detecting element is equipped for measuring a temperature of or near the laser beam source, and the inclination of the objective lens is adjusted by the tilt-compensating mechanism according to the amount of the change of the power of the laser beam and the temperature detected by the temperature-detecting element.

4. The optical recording-reproducing apparatus according to claim 1, wherein the apparatus is equipped with a means for acquiring a focus-driving signal for focusing to the disk medium, and detects a direction of the tilt of the disk medium according to the focus-driving signal, and the inclination of the objective lens is adjusted by the tilt-compensating mechanism in accordance with the result of the detection.

5. The optical recording-reproducing apparatus according to claim 1, wherein the power of the laser beam is adjusted in accordance with the amount of the compensation for tilt by the tilt-compensating mechanism.
